(19) United States
(12) Patent Application Publication
(10) Pub. No.: US 2024/0414381 A1
(43) Pub. Date: Dec. 12, 2024

(54) METHOD, APPARATUS, AND MEDIUM FOR DATA PROCESSING

(71) Applicants: Beijing Bytedance Network Technology Co., Ltd., Beijing (CN); Bytedance Inc., Los Angeles, CA (US)

(72) Inventors: Yaojun WU, Beijing (CN); Yue Li, Los Angeles, CA (US); Zhaobin Zhang, Los Angeles, CA (US); Semih Esenlik, Los Angeles, CA (US); Kai Zhang, Los Angeles, CA (US); Li Zhang, Los Angeles, CA (US)

(21) Appl. No.: 18/807,764

(22) Filed: Aug. 16, 2024

Related U.S. Application Data
(63) Continuation of application No. PCT/CN2023/076548, filed on Feb. 16, 2023.

(30) Foreign Application Priority Data
Feb. 17, 2022 (WO) PCT/CN2022/076708

(51) Int. Cl. H04N 19/91; H04N 7/01; H04N 19/60

(52) U.S. Cl. CPC H04N 19/91; H04N 7/01; H04N 19/60

(57) ABSTRACT

Embodiments of the present disclosure provide a solution for data processing. A method for data processing is proposed. The method comprises: determining, by using a first model with an attention mechanism during a conversion between data and a bitstream of the data, a probability distribution for entropy coding associated with the bitstream; and performing the conversion based on the probability distribution.

### CROSS REFERENCE

This application is a continuation of International Application No. PCT/CN2023/076548, filed on Feb. 16, 2023, which claims the benefit of International Application No. PCT/CN2022/076708, filed on Feb. 17, 2022. The entire contents of these applications are hereby incorporated by reference in their entireties.

### FIELDS

Embodiments of the present disclosure relates generally to data processing techniques, and more particularly, to transformer-based probability modeling for data coding.

### BACKGROUND

Image/video compression is an essential technique to reduce the costs of image/video transmission and storage in a lossless or lossy manner. Image/video compression techniques can be divided into two branches, the classical video coding methods and the neural-network-based video compression methods. Classical video coding schemes adopt transform-based solutions, in which researchers have exploited statistical dependency in the latent variables (e.g., wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs. Coding efficiency of image/video coding is generally expected to be further improved.

### SUMMARY

Embodiments of the present disclosure provide a solution for data processing.

In a first aspect, a method for data processing is proposed. The method comprises: determining, by using a first model with an attention mechanism during a conversion between data and a bitstream of the data, a probability distribution for entropy coding associated with the bitstream; and performing the conversion based on the probability distribution.

According to the method in accordance with the first aspect of the present disclosure, the probability distribution for entropy coding is obtained by using a first model with the attention mechanism. Compared with the conventional convolution-based solution, the first model can additionally capture long-range correlation among quantized latents. With the capability of capturing both the long-range and short-range correlations among the quantized latents, the first model has a better receptive field than the convolution-based solution. Thereby, the proposed method can advantageously improve the coding efficiency.

In a second aspect, an apparatus for data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of data which is generated by a method performed by an apparatus for data processing. The method comprises: determining, by using a first model with an attention mechanism, a probability distribution for entropy coding associated with the bitstream; and generating the bitstream based on the probability distribution.

In a fifth aspect, a method for storing a bitstream of data is proposed. The method comprises: determining, by using a first model with an attention mechanism, a probability distribution for entropy coding associated with the bitstream; generating the bitstream based on the probability distribution; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model;

FIG. 6 illustrates an encoding process of the combined model;

FIG. 7 illustrates a decoding process of the combined model;

FIG. 8 illustrates an example operation diagram of the transformer attention mechanism;

FIG. 9 illustrates an example framework of a method for data processing in accordance with embodiments of the present disclosure;

FIG. 10 illustrates an example structure of a transformer context model in accordance with embodiments of the present disclosure;

FIG. 11 illustrates an example operation diagram of a masked attention in accordance with embodiments of the present disclosure;

FIG. 12 illustrates a flowchart of a method for data processing in accordance with embodiments of the present disclosure; and

FIG. 13 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

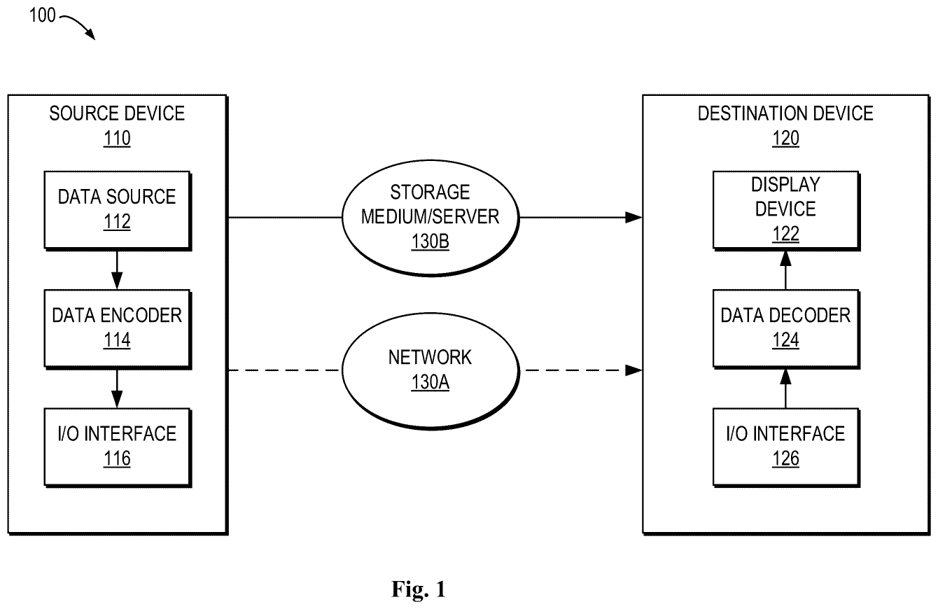

FIG. 1 is a block diagram that illustrates an example data coding system 100 that may utilize the techniques of this disclosure. As shown, the data coding system 100 may include a source device 110 and a destination device 120. The source device 110 can be also referred to as a data encoding device, and the destination device 120 can be also referred to as a data decoding device. In operation, the source device 110 can be configured to generate encoded data and the destination device 120 can be configured to decode the encoded data generated by the source device 110. The source device 110 may include a data source 112, a data encoder 114, and an input/output (I/O) interface 116.

The data source 112 may include a source such as a data capture device. Examples of the data capture device include, but are not limited to, an interface to receive data from a data provider, a computer graphics system for generating data, and/or a combination thereof.

The data may comprise one or more pictures of a video or one or more images. The data encoder 114 encodes the data from the data source 112 to generate a bitstream. The bitstream may include a sequence of bits that form a coded representation of the data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded data may be transmitted directly to destination device 120 via the I/O interface 116 through the network 130A. The encoded data may also be stored onto a storage medium/server 130B for access by destination device 120.

The destination device 120 may include an I/O interface 126, a data decoder 124, and a display device 122. The I/O interface 126 may include a receiver and/or a modem. The I/O interface 126 may acquire encoded data from the source device 110 or the storage medium/server 130B. The data decoder 124 may decode the encoded data. The display device 122 may display the decoded data to a user. The display device 122 may be integrated with the destination device 120, or may be external to the destination device 120 which is configured to interface with an external display device.

The data encoder 114 and the data decoder 124 may operate according to a data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific data codecs, the disclosed techniques are applicable to other coding technologies also. Furthermore, while some embodiments describe coding steps in detail, it will be understood that corresponding steps decoding that undo the coding will be implemented by a decoder. Furthermore, the term data processing encompasses data coding or compression, data decoding or decompression and data transcoding in which data are represented from one compressed format into another compressed format or at a different compressed bitrate.

### 1. INTRODUCTION

This disclosure is related to end-to-end image compression technologies. Specifically, it is about the probability modeling of entropy coding in learned image compression framework. The ideas can be applied individually or in various combination. It can be directly applied to the probability modeling of entropy in end-to-end Image compression framework. Besides, it also can be utilized as the intra part of the learned video compression, to aid the compression of residual information or intra frames in entropy part. Moreover, it may be also applied to conventional video coding standard like HEVC, or the standard Versatile Video Coding as a context modelling tools to further remove the redundancy inside the residual information.

### 2. ABBREVIATIONS

ANN Artificial Neural Network
E2E End-to-End
JPEG Joint Photographic Experts Group
MPEG Moving Picture Experts Group
VCEG Video Coding Experts Group
VTM VVC Test Model
VVC Versatile Video Coding

### 3. DISCUSSION

Image/video compression is an essential technique to reduce the costs of image/video transmission and storage in a lossless or lossy manner. Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

### 3.1. Conventional Image/Video Compression

Conventional image compression standardizations, such as JPEG, BPG, and VVC, adopt a hybrid framework to compress the input images. In these standardizations, a combination of the prediction, transformation, quantization and entropy coding is utilized to reduce the redundancy inside the image. Under the development over past serval decades, conventional codec improves the compression efficiency by nearly 50% each decade though hand craft design on some modules. A series of classical image coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image coding technology. The influential image coding standards published by these organizations include JPEG, JPEG 2000, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

### 3.2. Neural Network Based Compression Method

In recent five years, benefit from the great progress achieved by Artificial Neural Network (ANN), learning based solution for media coding create a new branch in image compression. In this branch, ANN will be utilized as a module to replace some functions inside the conventional codec, or fully replace the convention codec through an end-to-end manner. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field. Under the development of serval years, ANN based tools has shown some performance gains on conventional codec. As for the end-to-end ANN based image compression, it also achieves superior performance over the latest convention codec, VTM. Nevertheless, it still unmature and has much room to improve the compression performance.

### 3.3. Learned Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined in literature.

### 3.3.1. Pixel Probability Modeling

According to Shannon's information theory, the optimal method for lossless coding can reach the minimal coding rate −log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit −log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = \qquad ( 1 )$$

$$p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = \qquad ( 2 )$$

$$p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁. In an existing design, the pixel probability is proposed for binary images, i.e., xᵢ ∈{−1, +1}. The neural autoregressive distribution estimator (NADE) is designed for pixel probability modeling, where is a feed-forward network with a single hidden layer. A similar work is presented in an existing design, where the feed-forward network also has connections skipping the hidden layer, and the parameters are also shared. Both solutions perform experiments on the binarized MNIST dataset. In an existing design, NADE is extended to a real-valued model RNADE, where the probability p(xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. In an existing design, NADE and RNADE are improved by using reorganizing the order of the pixels and with deeper neural networks.

Designing advanced neural networks plays an important role in improving pixel probability modeling. In an existing design, multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images later. Several different neural networks are studied, including RNNs and CNNs namely PixelRNN and PixelCNN, respectively. In PixelRNN, two variants of LSTM, called row LSTM and diagonal BiLSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1, . . . , 255) and predict a multinomial distribution over the discrete values; they deal with color images in RGB color space; they work well on large-scale image dataset ImageNet. In an existing design, Gated PixelCNN is proposed to improve the PixelCNN, and achieves comparable performance with PixelRNN but with much less complexity. In an existing design, PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. In an existing design, PixelSNAIL is proposed, in which casual convolutions are combined with self-attention.

Most of the above methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 3.3.2. Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

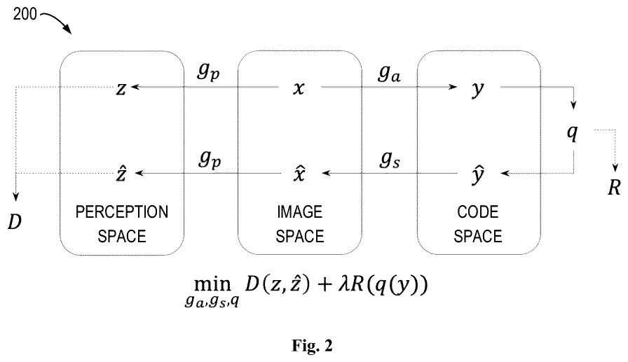

FIG. 2 illustrates a typical transform coding scheme. The original image x is transformed by the analysis network gₐ to achieve the latent representation y. The latent representation y is quantized and compressed into bits. The number of bits R is used to measure the coding rate. The quantized latent representation y is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 2, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ (ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype, and the difference might only be the network structure or loss function.

In terms of network structure, RNNs and CNNs are the most widely used architectures. In the RNNs relevant category, Toderici et al. propose a general framework for variable rate image compression using RNN. They use binary quantization to generate codes and do not consider rate during training. The framework indeed provides a scalable coding functionality, where RNN with convolutional and deconvolution layers is reported to perform decently. Toderici et al. then proposed an improved version by upgrading the encoder with a neural network similar to PixelRNN to compress the binary codes. The performance is reportedly better than JPEG on Kodak image dataset using MS-SSIM evaluation metric. Johnston et al. further improve the RNN-based solution by introducing hidden-state priming. In addition, an SSIM-weighted loss function is also designed, and spatially adaptive bitrates mechanism is enabled. They achieve better results than BPG on Kodak image dataset using MS-SSIM as evaluation metric. Covell et al. support spatially adaptive bitrates by training stop-code tolerant RNNs.

Ballé et al. proposes a general framework for rate-distortion optimized image compression. The use multiary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified in an existing design. Ballé et al. then propose an improved version, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, Ballé et al. improve the method by devising a scale hyper-prior into the auto-encoder. They transform the latent representation y with a subnet hₐ to z hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. D. Minnen et al. further exploit the structures in the residue space by introducing an autoregressive model to estimate both the standard deviation and the mean. In an existing design, Z. Cheng et al. use Gaussian mixture model to further remove redundancy in the residue. The reported performance is on par with VVC on the Kodak image set using PSNR as evaluation metric.

### 3.3.3. Hyper Prior Model

In the transform coding approach to image compression, the encoder subnetwork (section 3.3.2) transforms the image vector x using a parametric analysis transform gₐ(x, Ø_{g}) into a latent representation y, which is then quantized to form ŷ. Since ŷ is discrete valued, it can be losslessly compressed using entropy coding techniques such as arithmetic coding and transmitted as a sequence of bits.

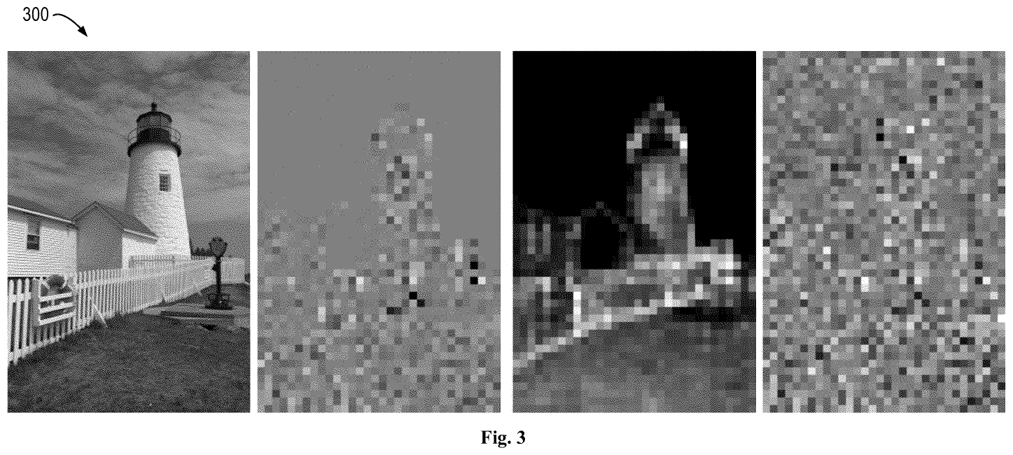

FIG. 3 illustrates an image from the Kodak dataset and different representations of the image. The leftmost image in FIG. 3 shows an image from the Kodak dataset. The middle left image in FIG. 3 shows visualization of a latent representation y of that image. The middle right image in FIG. 3 shows standard deviations a of the latent. The rightmost image in FIG. 3 shows latents y after the hyper prior (hyper encoder and decoder) network is introduced.

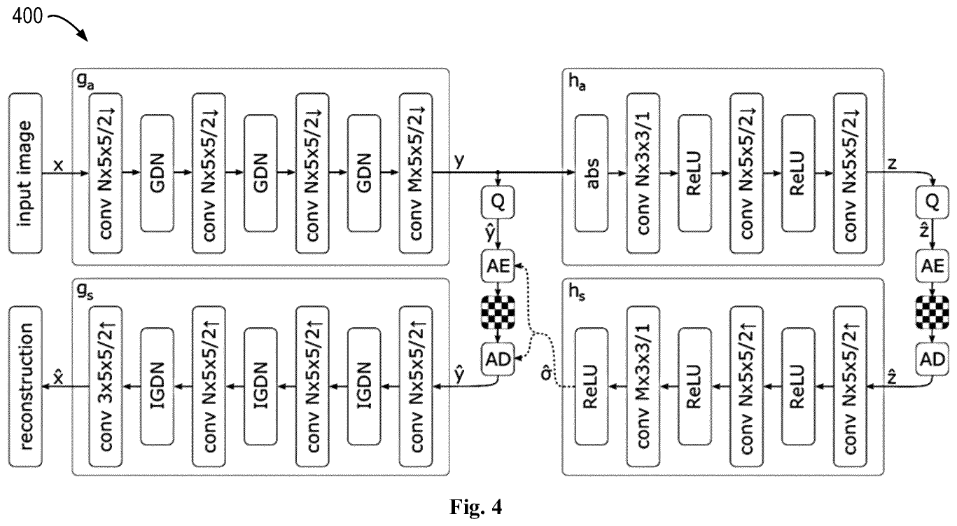

As evident from the middle left and middle right image of FIG. 3, there are significant spatial dependencies among the elements of ŷ. Notably, their scales (middle right image) appear to be coupled spatially. An additional set of random variables \hat{z} are introduced to capture the spatial dependencies and to further reduce the redundancies. In this case the image compression network is depicted in FIG. 4.

In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 3 correspond to the quantized latent when hyper encoder/decoder are used. Compared to middle right image, the spatial redundancies are significantly reduced, as the samples of the quantized latent are less correlated.

FIG. 4 illustrates a network architecture of an autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{x} is included in the bitstream and transmitted to the receiver (decoder) along with ŷ.

### 3.3.4. Context Model

Although the hyper prior model improves the modelling of the probability distribution of the quantized latent ŷ, additional improvement can be obtained by utilizing an autoregressive model that predicts quantized latent from their causal context (Context Model).

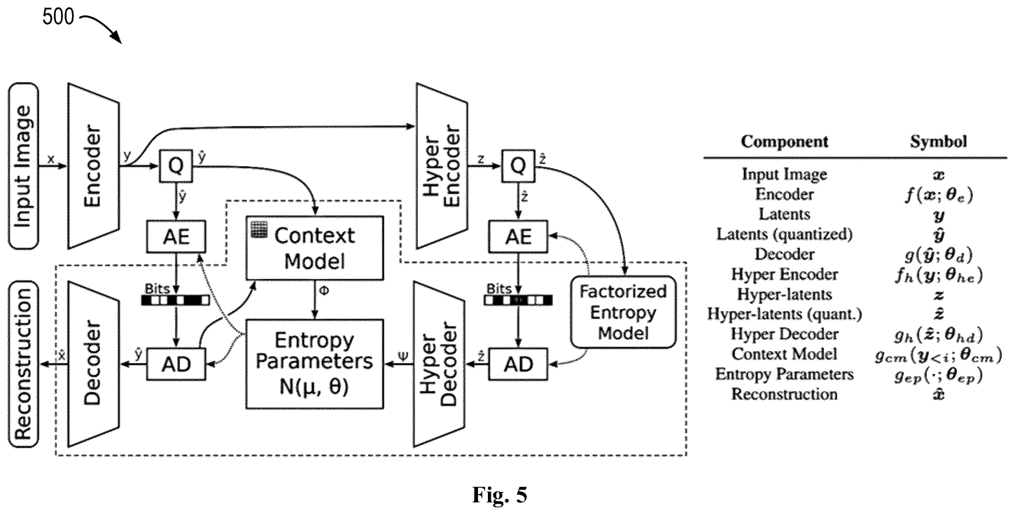

FIG. 5 illustrates a block diagram of a combined model. The combined model jointly optimizes an autoregressive component that estimates the probability distributions of latent from their causal context (Context Model) along with a hyperprior and the underlying autoencoder. Real-valued latent representations are quantized (Q) to create quantized latent (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

The term auto-regressive means that the output of a process is later used as input to it. For example, the context model subnetwork generates one sample of a latent, which is later used as input to obtain the next sample.

In an existing design, a joint architecture is used where both hyper prior model subnetwork (hyper encoder and hyper decoder) and a context model subnetwork are utilized. The hyper prior and the context model are combined to learn a probabilistic model over quantized latent ŷ, which is then used for entropy coding. As depicted in FIG. 5, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latent ŷ from the bitstream by arithmetic decoder (AD) module.

Typically, the latent samples are modeled as gaussian distribution or gaussian mixture models (not limited to). In an existing design and according to the FIG. 5, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 3.3.5. The Encoding Process Using Joint Auto-Regressive Hyper Prior Model

The FIG. 5. corresponds to the state-of-the-art compression method. In this section and the next, the encoding and decoding processes will be described separately.

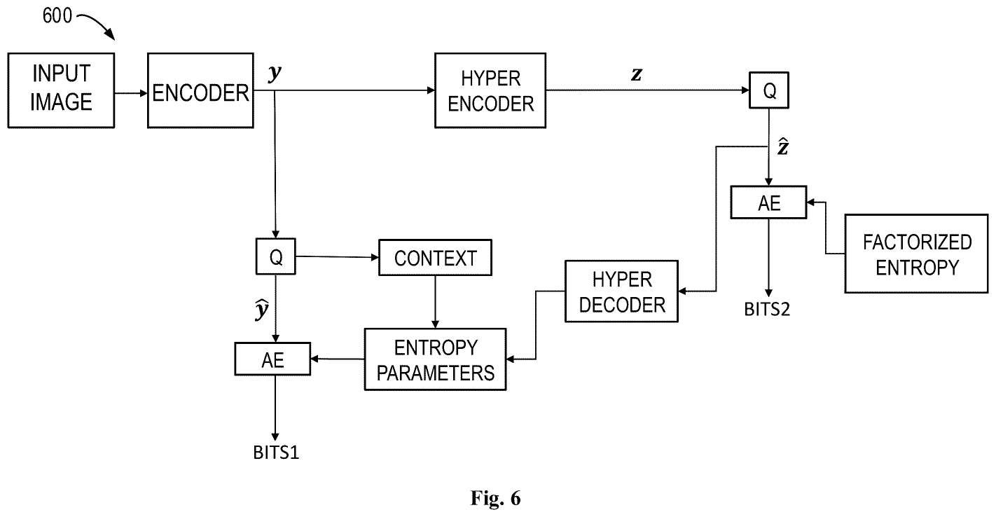

The FIG. 6 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined a

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i, j, k] or ŷ[i, j] depending on the dimensions of the matrix ŷ. The samples ŷ[i, j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i, j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all elements in FIG. 6 are collectively called encoder. The analysis transform that converts the input image into latent representation is also called an encoder (or auto-encoder).

### 3.3.6. The Decoding Process Using Joint Auto-Regressive Hyper Prior Model

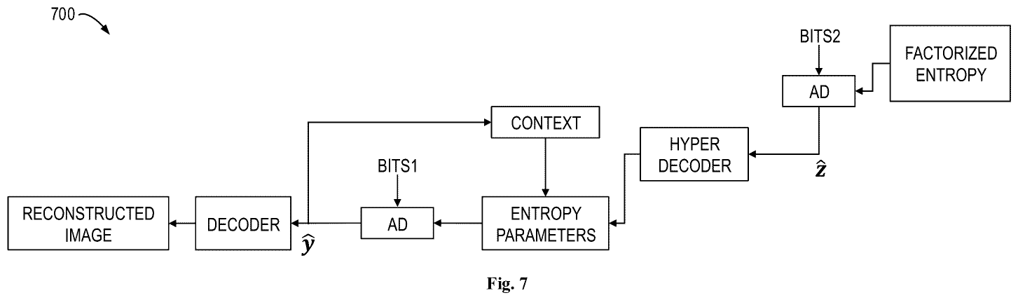

The FIG. 7 depicts the decoding process separately. In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally, the fully reconstructed quantized latent ŷ is input to the synthesis transform (denoted as decoder in FIG. 7) module to obtain the reconstructed image. In the above description, all of the elements in FIG. 7 are collectively called decoder. The synthesis transform that converts the quantized latent into reconstructed image is also called a decoder (or auto-decoder).

### 3.4. Neural Networks Based Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 3.4.1. Low-Latency

Chen et al. are the first to propose a video compression scheme with trained neural networks. They first split the video sequence frames into blocks and each block will choose one from two available modes, either intra coding or inter coding. If intra coding is selected, there is an associated auto-encoder to compress the block. If inter coding is selected, motion estimation and compensation are performed with tradition methods and a trained neural network will be used for residue compression. The outputs of auto-encoders are directly quantized and coded by the Huffman method.

Chen et al. propose another neural network-based video coding scheme with PixelMotionCNN. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme. This scheme performs on par with H.264.

Lu et al. propose the real-sense end-to-end neural network-based video compression framework, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

Rippel et al. propose an advanced neural network-based video compression scheme. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in MS-SSIM than HEVC reference software.

J. Lin et al. propose an extended end-to-end neural network-based video compression framework. In this solution, multiple frames are used as references. It is thereby able to provide a more accurate prediction of the current frame by using multiple reference frames and associated motion information. In addition, motion field prediction is deployed to remove motion redundancy along the temporal channel. Postprocessing networks are also introduced in this work to remove reconstruction artifacts from previous processes. The performance is better than H.265 by a noticeable margin in terms of both PSNR and MS-SSIM.

Eirikur et al. propose scale-space flow to replace commonly used optical flow by adding a scale parameter based on the framework of an existing design. It is reportedly achieving better performance than H.264.

Z. Hu et al. propose a multi-resolution representation for optical flows. Concretely, the motion estimation network produces multiple optical flows with different resolutions and lets the network learn which one to choose under the loss function. The performance is slightly improved and better than H.265.

### 3.4.2. Random Access

Wu et al. propose a neural network-based video compression scheme with frame interpolation. The keyframes are first compressed with a neural image compressor and the remaining frames are compressed in a hierarchical order. They perform motion compensation in the perceptual domain, i.e., deriving the feature maps at multiple spatial scales of the original frame and using motion to warp the feature maps, which will be used for the image compressor. The method is reportedly on par with H.264.

Djelouah et al. propose a method for interpolation-based video compression, wherein the interpolation model combines motion information compression and image synthesis, and the same auto-encoder is used for image and residual.

Amirhossein et al. propose a neural network-based video compression method based on variational auto-encoders with a deterministic encoder. Concretely, the model consists of an auto-encoder and an auto-regressive prior. Different from previous methods, this method accepts a group of pictures (GOP) as inputs and incorporates a 3D autoregressive prior by considering the temporal correlation while coding the latent representations. It provides comparative performance as H.265.

### 3.5. Transformer for Computer Vision Task

Transformer models have recently demonstrated superior performance on a broad range of natural language tasks e.g., text classification, machine translation, and question answering. Inspired by the success of the transformer in natural language processing, transformer models and their variants have been migrated to computer vision tasks, such as image recognition, object detection, segmentation, image super-resolution, and shows compelling performance compared with convolution neural networks.

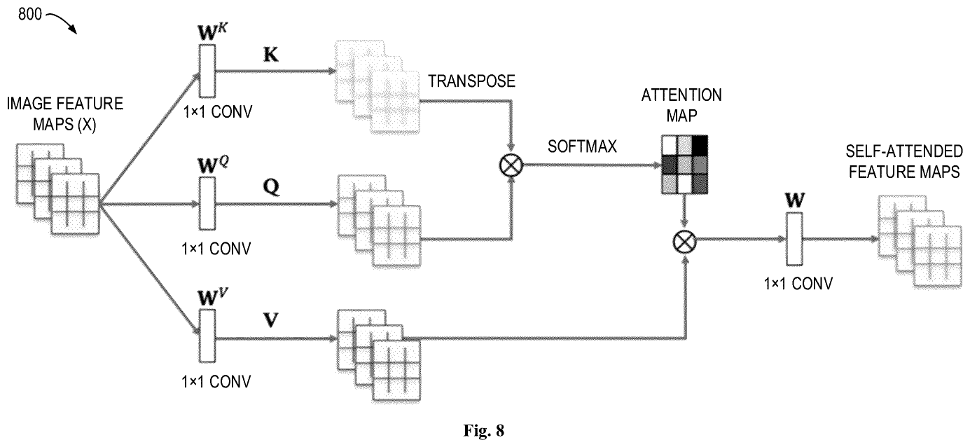

Different from convolution networks, transformer features model long-range dependencies between input sequence elements, which leads to exciting progress on several vision tasks using Transformer networks. The key idea of the transformer is the attention mechanism, which is exemplified in FIG. 8.

FIG. 8 illustrates an example operation diagram of the transformer attention mechanism. Given the input sequence, the triplets of key, query, and value are calculated. An attention map is derived from these triplets and used to reweight the values.

Given a sequence, attention mechanism, estimated the relation of one element to other elements, to seek most related information in the whole sequence. Through relation calculation, relation weights matrix is obtained by QK^{T}. After the relation calculation, normalization is performed to get relative relation results. Then the relative relation is used as the weights, the weighted sum of all elements in inputs is calculated to aggerated related information. Since the calculation of the relation matrix is a global calculation involving all the elements, transformer-based solutions have a much better receptive field than convolution solutions, which leads to the success of the current transformer-based method.

### 4. PROBLEMS

As illustrated in FIG. 4, to build the relationship between adjacent spatial elements inside the quantized latent ŷ, the state-of-the-art intra compression framework includes an autoregressive model and hyperprior model. Both of them are designed to reduce the redundancy between elements in different spatial locations. However, this may lead to the following problems:
1. Limited by the receptive field of the convolution layers, the autoregressive model and hyperprior model can only model the correlations among the quantized latents in a limited range, but lacks the capability to capture long-range correlations.
2. The Transformer has the ability to model the long-range relationships. However, it is not auto-regressive, which is essential for the decoding process.

### 5. DETAILED SOLUTIONS

To solve the above problems and some other problems not mentioned, methods as summarized below are disclosed. The solutions should be considered as examples to explain the general concepts and should not be interpreted in a narrow way. Furthermore, these solutions can be applied individually or combined in any manner.

The techniques described herein provide a probability modeling method that is utilized in end-to-end image compression. The transformer is applied to the current end-to-end image compression framework to capture the relationship in a long spatial range. Benefit from the capability of capturing both the long-range and short-range correlations among the quantized latents, the proposed method achieves better compression efficiency. In summary, the solution includes the following aspects:
1) To solve the first problem, the transformer is introduced into the entropy probability modeling part, which can be combined with the current model through one or more of the following approaches:
   a. In one example, the transformer can be used as a plug-in module in probability modeling and combined with the existing autoregressive model and hyperprior model to boost the coding performance:
      i. In one example, the output of the encoder can be used as the input of the transformer. And the output of the transformer can combine with the output of the autoregressive model and hyperprior model to obtain the probability distribution for entropy coding.
         1. In one example, the output of the transformer is combined with the output of the autoregressive model and hyperprior model as the input of a sub-network. The probability distribution for entropy coding is obtained by the output of the sub-network.
      ii. In one example, latent that comes from the encoder and autoregressive/hyperprior model can be utilized as the input of the transformer.
         1. In one example, the output of the transformer may combine with the hyperprior/autoregressive model through an additional subnetwork.
         2. Alternatively, the output of the transformer may combine with the hyperprior/autoregressive model directly.
      iii. In one example, latent that comes from the encoder and additional subnetwork can be utilized as the input of the transformer. The output of the transformer can combine with the output of the autoregressive model and hyperprior model to obtain the probability distribution for entropy coding.
         1. In one example, the quantized latent ŷ is the input of the additional subnetwork.
         2. In one example, the latent y is the input of the additional subnetwork.
         3. In one example, the original image x is the input of the additional subnetwork.
      iv. In one example, whether transformer is used as a plug-in module may be signaled from an encoder to a decoder.
      v. In one example, whether transformer is used as a plug-in module may be derived by the decoder.
   b. In one example, the transformer also can be utilized to completely replace the existing entropy module, which can remove long-range and short-range redundancy between elements in different spatial levels:
      i. In one example, the transformer can replace the autoregressive model, and the hyperprior model can cooperate with the transformer to obtain the required probability distribution.
         1. In one example, the output of the encoder and hyperprior model can be fed into the transformer to obtain the probability distribution for entropy coding.
         2. In one example, the output of the encoder may be the input of the transformer only.
         a. In one example, the output of the transformer may not be directly used in entropy coding. It may combine with the output hyperprior through an additional subnetwork to obtain probability distribution for entropy coding.
         b. Alternatively, the output of the transformer is just the probability distribution of the elements to be coded.
      ii. In one example, the transformer can replace the hyperprior model. The autoregressive model can cooperate with the transformer to obtain the required probability distribution.
         1. In one example, the output of the encoder and autoregressive model can be fed into the transformer to obtain the probability distribution for entropy coding directly.
         2. In one example, the output of the encoder may be the input of the transformer only.
         a. In one example, the output of the transformer may not be directly used in entropy coding. It may combine with the output autoregressive model through an additional subnetwork to obtain probability distribution for entropy coding.
         b. Alternatively, the output of the transformer is just the probability distribution of the elements to be coded.
      iii. In one example, the transformer can replace the hyperprior model and autoregressive model to obtain the required probability distribution.
         1. In one example, the output of the encoder may be treated as the input of the transformer.
         2. In one example, the output of the encoder and additional network may be treated as the input of the transformer.
         a. In one example, ŷ is the input of the additional subnetwork.
         b. In one example, the original image x is the input of the additional subnetwork.
      iv. In one example, whether transformer is used to replace the autoregressive model and/or the hyperprior model may be signaled from an encoder to a decoder.
      v. In one example, whether transformer is used to replace the autoregressive model and/or the hyperprior model may be derived by the decoder.
   c. More than one transformer model may be used.
      i. In one example, several transformers may be used to predict the probability of all elements respectively, and their results can be combined to obtain final probability results.
         1. In one example, the combination process may be weighted sum, and the weights can be derived by learnable parameters or latent information.
         2. In one example, the combination process may be handled by serval neural networks.
      ii. In one example, elements that in different spatial locations may use different transformer models.
      iii. In one example, which transformer model to be used may be signaled from an encoder to a decoder.
         1. In one example, the signaled information may be obtained through RD loss estimation.
         2. In one example, the signaled information may be obtained through latent information.
      iv. In one example, which transformer model to be used may be derived by the decoder.
         1. In one example, the signaled information may be obtained through hyperprior information.
         2. In one example, the signaled information may be obtained through the autoregressive model.
         3. In one example, the signaled information may be obtained through the combination of hyperprior information and autoregressive model.
2) To solve the second issue, the transformer context model is designed to obtain global relationships in an autoregressive way. One or more of the following approaches are disclosed:
   a. In one example, the input ŷ is fed into the transformer, it may be used to derive query, key and values to finish attention calculation. One or more networks may process the output of the attention calculation to obtain context parameter for entropy probability modeling:
      i. In one example, input latent ŷ may be processed by three different sub-networks to obtain query, key, and value information for global relation calculation.
      ii. In one example, input latent ŷ may directly be set as query, key, and value.
      iii. In one example, to ensure the auto-regressive characteristics, the mask will be used on the relation matrix:
         1. In one example, strictly lower triangle matrix may be used:
         a. In one example, a strictly lower triangle matrix may be used as the mask.
         b. Alternatively, a subset of the strictly lower triangle matrix may be used as the mask.
         2. In one example, a lower triangle matrix is used. Since elements on the diagonal of the matrix cannot be obtained by the autoregressive manner, these elements will be treated as side information and transmitted in bitstream.
         a. In one example, the lower triangle matrix may be used as the mask.
         b. Alternatively, a subset of the lower triangle matrix may be used as the mask.
         3. In one example, the lower triangle matrix is used, sum of the query on channel dimension is used as a substitution of elements on the diagonal of the matrix.
         a. In one example, the lower triangle matrix may be used as the mask.
         b. Alternatively, a subset of the lower triangle matrix may be used as the mask.
         4. In one example, the lower triangle matrix is used. Additional information will be used to substitute the elements on the diagonal of the matrix.
         a. In one example, the lower triangle matrix may be used as the mask.
         b. Alternatively, a subset of the lower triangle matrix may be used as the mask.
         c. In one example, the substitution is derived from the information from the hyperprior/autoregressive model.
         5. In one example, the full matrix is used. Additional information will be used to substitute the elements on the upper triangle matrix.
         a. In one example, the substitution is derived from the information that comes from the hyperprior/autoregressive model.
      iv. In one example, a different number of attention modules may be utilized:
         1. In one example, only one attention module is used.
         2. Alternatively, a multiply attention module will be used to obtain results respectively, and then aggregated to get results.
         a. In one example, the aggregation method may be concatenation in the channel/spatial domain.
         b. Alternatively, the aggregation method may be linear operation (add/subtract).
   b. In one example, input ŷ and additional information are fed into the transformer. ŷ is processed as key and values information, while additional information will be used as the query information, and several networks may process the output of the attention calculation to obtain context parameter that needed for entropy probability modeling:
      i. In one example, input latent ŷ and additional information may be processed by three sub-networks to obtain query, key, and value information respectively for global relation calculation.
      ii. In one example, input latent ŷ may be directly set as key and value, and additional information can be directly set as the query.
      iii. In one example, the additional information is derived from the information that comes from the hyperprior/autoregressive model.
      iv. In one example, to ensure the auto-regressive characteristics, a mask is used on the relation matrix.
         1. In one example, a strictly triangle matrix may be used:
         a. In one example, a strictly lower triangle matrix may be used as the mask.
         b. Alternatively, a subset of the strictly lower triangle matrix may be used as the mask.
         2. In one example, a triangle matrix is used. Since elements on the diagonal of the relation matrix cannot be obtained in an autoregressive manner, the self-correlation of the query is used as a substitution of the diagonal elements.
         a. In one example, the lower triangle matrix may be used as the mask.
         b. Alternatively, a subset of the lower triangle matrix may be used as the mask.
      v. In one example, the entire matrix is used. Since the upper triangle matrix elements cannot be obtained on the decoding side, additional information is used as the query and key to getting results in the corresponding area.
         1. In one example, the entire matrix is used.
         2. In one example, a subset of the entire matrix is used.
      vi. In one example, a different number of attention modules may be utilized:
         1. In one example, only one attention module is used.
         2. Alternatively, a multiply attention module will be used to obtain results respectively, and then aggregated to get results.
         a. In one example, the aggregation method may be concatenation in the channel/spatial domain.
         b. Alternatively, the aggregation method may be linear operation (add/subtract).
3) Transformer model may be used in image coding or video coding.
   a. In one example, Transformer model may be used with prediction results.
      i. In one example, intra prediction results may be applied in Transformer.
      ii. Alternatively, inter prediction results may be used.
   b. In one example, Transformer model may be used with motion information.
      i. In one example, Transformer may be combined with the motion vector.
      ii. In one example, Transformer may be combined with optical flow.
      iii. In one example, Transformer may be combined with latent motion information.
   c. In one example, previously coded frames may be used in Transformer.

### 6. EMBODIMENTS

This embodiment describes an example of how designed transformer module solve the issue of long range relationship modeling.

### 6.1. Overall Framework

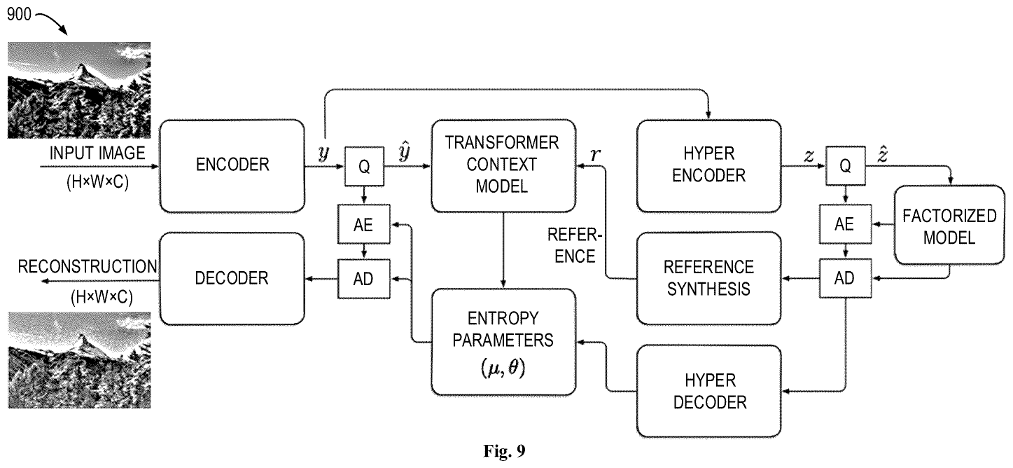

FIG. 9 illustrates one possible framework of the proposed method. In this embodiment, the transformer is utilized as a replacement of the autoregressive model. In detail, for input image x, encoder network gₐ with parameter ϕ_{ga} transform it into latent information y:

$$y = {g}_{a} ( x ; {ϕ}_{g a} ) . \qquad ( 4 )$$

Then it is quantized to reduce the information through quantization function Q(.), which can be formulated as:

$$\hat{y} = Q ( y ) . \qquad ( 5 )$$

The round operation is utilized in the testing phase in the Quantization part. Since rounding operation is non-differential, uniform noise u(−0.5, 0.5) is utilized as a substitution in the training phase, which can be formulated as:

$$Q ( a ) = \{ \begin{matrix}round ( a ) & when testing , \\ a + u ( - 0.5 , 0.5 ) & when training .\end{matrix} \qquad ( 6 )$$

In the entropy coding part, hyperprior encoder hₐ with parameters ϕₕₐ is firstly utilized, which takes latent y as the input and output hyperprior information z. Similar to y, hyperprior information z is quantized by quantization function Q(.), then the probability distribution p_{\hat{z}} of the quantized information \hat{z} is estimated by factorized model F. The above procedure can be formulated as:

$$\hat{z} = Q ( \hat{z} ) = Q ( {h}_{a} ( y ; {ϕ}_{h a} ) ) \qquad ( 7 )$$

$${p}_{\hat{z}} = F ( \hat{z} ; {ϕ}_{f} ) \qquad ( 8 )$$

After that, arithmetic encoding can convert \hat{z} into bitstream according to the p_{z}. To decode \hat{z}, a corresponding inverse operation is performed through the arithmetic decoding process. Then decoded \hat{z} is respectively fed into reference synthesis network R_{f} and hyper decoder hₛ. The reference synthesis network R_{f} is to obtain reference information r for the transformer context model, while hyper decoder hₛ generates information for entropy estimation module e.

Besides the hyperprior model, transformer context model t is also utilized to aid probability distribution modeling. Specifically, the quantized latent ŷ and additional information p are the input of the t, and the output of the t is combined with the output of the hyper decoder hₛ through entropy estimation module e. In estimation module e, the probability distribution of the ŷ is modeled as a Gaussian distribution, and the output of the e is the estimated mean μ and standard deviation σ of the p_{y}:

$${p}_{\hat{y}} = N ( μ , σ ) = N ( e ( t ( \hat{y} , p ; {ϕ}_{t} ) , {h}_{s} ( \hat{z} ; {ϕ}_{h s} ) ; {ϕ}_{e} ) ) \qquad ( 9 )$$

$$= N ( e ( t ( \hat{y} , {R}_{f} ( \hat{z} ; {ϕ}_{R} ) ; {ϕ}_{t} ) , {h}_{s} ( \hat{z} ; {ϕ}_{h s} ) ; {ϕ}_{e} ) ) ,$$

where ϕₑ, ϕₜ, ϕ_{R}_{_{f}}, ϕₕₛ respectively represent the parameters of e, t, R_{f} and hₛ, N means Gaussian distribution function.

Based on the estimated probability distribution p_{ŷ}, the encoder can convert quantized latent ŷ into bitstream through arithmetic encoding, and convert it back by the inverse operation. On the decoder side, after obtaining quantized latent ŷ, decoder network gₛ with parameters ϕ_{gs} will take it as input and obtain final reconstruction \hat{x}.

### 6.2. Transformer Context Model and Reference Synthesis Network

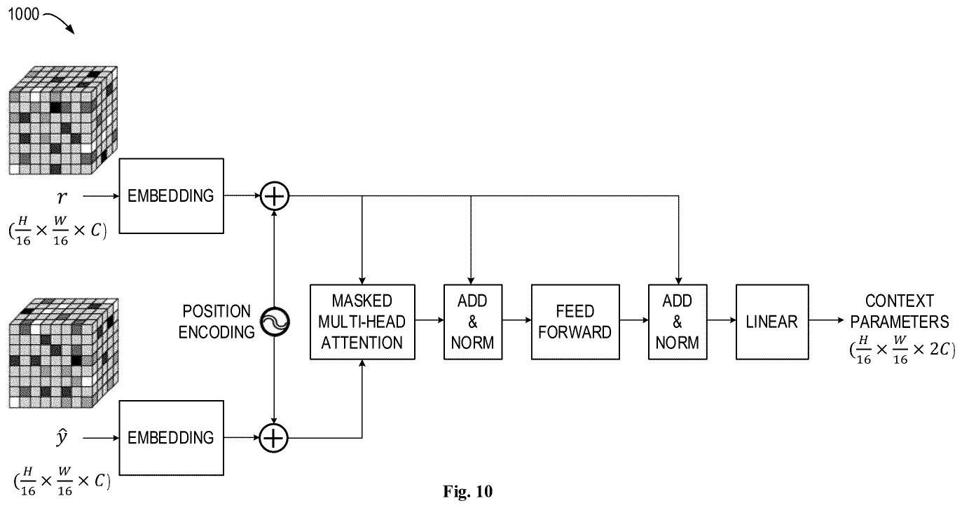

To obtain global relationship inside quantized latent ŷ, the transformer context model is utilized in the framework, and FIG. 10 illustrates a possible structure of the transformer context model.

For input reference information r and quantized latent ŷ, different embedding layer is utilized respectively to vanish the domain gap between reference information r and quantized latent ŷ. Specifically, a single convolution layer with a 1×1 kernel size is used in the embedding layer. After the embedding layer, position encoding is performed on the output of the embedding layer. Position encoding contains a learnable tensor with the shape of (16, 16, C). It marks the spatial location of latent information and is combined with the output of the embedding layer through addition operation.

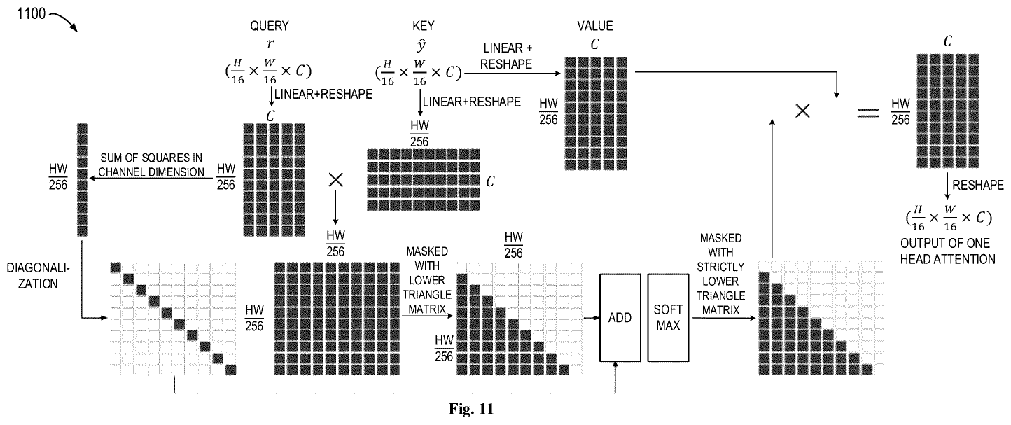

To implement the autoregressive procedure, masked attention is performed in the transformer context model. FIG. 11 shows one possible solution of the masked attention:

In detail, r is set as query information, and ŷ is the key and value information. Both r and ŷ are flattened to 2D matrixes through the raster scan order in the spatial domain. To obtain the correlation matrix between query and key, matrix multiplication is used after the flatten operation.

Since the self-correlation on current elements to be decoded and correlation between current element and undecoded elements are not available in the decoder phase, a strictly lower triangle mask is utilized on the correlation matrix.

As the substitution of the self-correlation, the square sum of query in the channel dimension will be used, it is diagonalized and then combined with the masked matrix. After that, SoftMax is utilized to normalize the relation matrix. The output of SoftMax is masked with a strictly lower triangle matrix to ensure the autoregressive when calculated with value information. Finally, based on the relative relation matrix, most related elements that before elements to be coded/decoded is combined through the multiple of masked relation matrix and value.

To enhance the fitting ability of the model, a multiple mask attention model is adopted. It processes the input information respectively and combined by concatenation operation. The combination of several masked attention modules is called masked multi-head attention module. Specifically, the number of the multi-head attention that is used in this solution is p_{ŷ}.

After the masked multi-head attention module, the latent information is further processed by residual connection, normalization, and linear layer. The final output is combined with the output of the hyperprior decoder to obtain the final probability distribution of p_{ŷ}.

More details of the embodiments of the present disclosure will be described below which are related to transformer-based probability modeling for data coding. As used herein, the term “data” may refer to an image, a picture in a video, a video, or any other data suitable to be coded.

As discussed above, in order to build the relationship between adjacent spatial elements in the quantized latent representation ŷ of data, the existing coding framework includes an autoregressive model (such as a context model shown in FIGS. 6 and 7) and a hyperprior model (such as a hyper encoder and/or a hyper decoder shown in FIGS. 6 and 7). Both of them are designed to reduce the redundancy between elements in different spatial locations. However, due to the limited receptive field of convolution layers, the autoregressive model and hyperprior model can only model the correlations among the quantized latents in a limited range but lacks the capability to capture long-range correlations.

To solve the above problems and some other problems not mentioned, data processing solutions as described below are disclosed. The embodiments of the present disclosure should be considered as examples to explain the general concepts and should not be interpreted in a narrow way. Furthermore, these embodiments can be applied individually or combined in any manner.

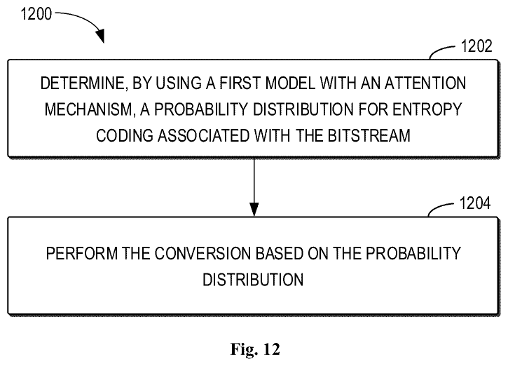

FIG. 12 illustrates a flowchart of a method 1200 for data processing in accordance with some embodiments of the present disclosure. The method 1200 may be implemented during a conversion between the data and a bitstream of the data. As shown in FIG. 12, the method 1200 starts at 1202, where a probability distribution for entropy coding associated with the bitstream is determined by using a first model with an attention mechanism. As used herein, the term “attention mechanism” may refer to an existing mechanism used in neural networks to model long-range relationships, for example across a text in the context of natural language processing (NLP). In aid of the attention mechanism, shortcuts may be built between a context vector and the input, to allow a model to attend to different parts.

By way of example rather than limitation, the first model may be used as a plug-in module in probability modeling. In other words, the first model may be used in combination with an autoregressive model and a hyperprior model to determine the probability distribution. In one example, intermediate information may be determined based on a quantized latent representation of the data by using the first model. Moreover, the probability distribution may be generated based on the intermediate information and an output of the autoregressive model and an output of the hyperprior model. For example, the probability distribution is generated by using a further model different from the first model. In some embodiments, the first model may be designed based on a transformer architecture, and may be referred to as a transformer, a transformer model, a transformer context model, and/or the like. Fur purpose of illustration, FIG. 10 illustrates an example structure of a transformer context model in accordance with embodiments of the present disclosure. It should be understood that the above examples are described merely for purpose of description. The scope of the present disclosure is not limited in this respect.

At 1204, the conversion is performed based on the probability distribution. In one example, the conversion may include encoding the data into the bitstream. Entropy encoding (such as arithmetic encoding or Huffman encoding) may be performed on quantized information based on the probability distribution, so as to generating the bitstream. Alternatively or additionally, the conversion may include decoding the data from the bitstream. Entropy decoding (such as arithmetic decoding or Huffman decoding) may be performed on the bitstream based on the probability distribution, so as to obtain the quantized information which may be further processed to reconstruct the data. It should be understood that the above illustrations are described merely for purpose of description. The scope of the present disclosure is not limited in this respect.

In view of the foregoing, the probability distribution for entropy coding is obtained by using a first model with the attention mechanism. Compared with the conventional convolution-based solution, the first model can additionally capture long-range correlation among quantized latents. With the capability of capturing both the long-range and short-range correlations among the quantized latents, the first model has a better receptive field than the convolution-based solution. Thereby, the proposed method can advantageously improve the coding efficiency.

In some embodiments, at 1202, intermediate information may be generated based on a quantized latent representation of the data and a first output of the autoregressive model by using the first model. Furthermore, the probability distribution may be generated based on the intermediate information and a second output of the hyperprior model. In one example, the probability distribution may be generated based on the intermediate information and the second output by a further model. Alternatively, the probability distribution may be generated by combining the intermediate information and the second output directly.

In some alternative embodiments, at 1202, intermediate information may be generated based on a quantized latent representation of the data and a second output of the hyperprior model by using the first model. Furthermore, the probability distribution may be generated based on the intermediate information and a first output of the autoregressive model. In one example, the probability distribution may be generated based on the intermediate information and the first output by a further model. Alternatively, the probability distribution may be generated by combining the intermediate information and the first output directly.

In some embodiments, at 1202, intermediate information may be generated based on a quantized latent representation of the data and an output of a further model by using the first model. Moreover, the probability distribution may be generated based on the intermediate information, a first output of the autoregressive model and a second output of the hyperprior model. By way of example rather than limitation, an input of the further model may comprise at least one of: the data, a latent representation of the data, or a quantized latent representation of the data.

In some embodiments, information on whether the probability distribution is determined by using a combination of the first model with an autoregressive model and a hyperprior model may be indicated in the bitstream. In other words, whether the first model is used as a plug-in module may be signaled in the bitstream. Alternatively, information on whether the probability distribution is determined by using a combination of the first model with an autoregressive model and a hyperprior model may be determined by a decoder.

In some embodiments, the probability distribution may be determined by using a combination of the first model with a hyperprior model. For example, the first model may be used to replace the autoregressive model and cooperate with the hyperprior model to generate the probability distribution. In one example, the probability distribution may be determined based on a quantized latent representation of the data and an output of the hyperprior model by using the first model. Alternatively, an input of the first model may comprise a quantized latent representation of the data. In some embodiments, the probability distribution may be determined based on an output of the first model and an output of the hyperprior model by using a further model. Alternatively, the probability distribution may be determined as an output of the first model.

In some alternative embodiments, the probability distribution may be determined by using a combination of the first model with an autoregressive model. For example, the first model may be used to replace the hyperprior model and cooperate with the autoregressive model to generate the probability distribution. In one example, the probability distribution may be determined based on a quantized latent representation of the data and an output of the autoregressive model by using the first model. Alternatively, an input of the first model may comprise a quantized latent representation of the data. In some embodiments, the probability distribution may be determined based on an output of the first model and an output of the autoregressive model by using a further model. Alternatively, the probability distribution may be determined as an output of the first model.

In some embodiments, the probability distribution may be determined by using the first model. For example, the first model may be used to replace the autoregressive model and the hyperprior model. In one example, an input of the first model may comprise a quantized latent representation of the data. Alternatively, the input may further comprise an output of a further model. For example, an input of the further model may comprise at least one of: the data, or a quantized latent representation of the data.

In some embodiments, information on whether the first model is used to replace an autoregressive model may be indicated in the bitstream. Information on whether the first model is used to replace a hyperprior model may be indicated in the bitstream. Additionally or alternatively, information on whether the first model is used to replace the autoregressive model and the hyperprior model may be indicated in the bitstream.

In some alternative embodiments, information on whether the first model is used to replace an autoregressive model may be determined by a decoder. Information on whether the first model is used to replace a hyperprior model may be determined by a decoder. Additionally or alternatively, information on whether the first model is used to replace the autoregressive model and the hyperprior model may be determined by a decoder.

In some embodiments, the probability distribution may be determined by using a plurality of the first models. For example, more than one transformer model may be used. By way of example rather than limitation, at 1202, a first candidate probability distribution for the entropy coding may be determined by using one of the plurality of the first models. A second candidate probability distribution for the entropy coding may be determined by using a further one of the plurality of the first models. In addition, the probability distribution may be generated based on the first candidate probability distribution and the second candidate probability distribution. In one example, the probability distribution may be generated based on a weighted sum of the first candidate probability distribution and the second candidate probability distribution. Weights for the first candidate probability distribution and the second candidate probability distribution may be determined based on learnable parameters or latent information. In another example, the probability distribution is generated by at least one further model, such as neural network.

In some embodiments, one of the plurality of the first models may be used for a first element at a first spatial location of a quantized latent representation of the data. A further one of the plurality of the first models may be used for a second element at a second spatial location of the quantized latent representation. The second element spatial location is different from the first element spatial location. For example, elements that in different spatial locations may use different transformer models.

In some embodiments, information on the first model to be used may be indicated in the bitstream. For example, which first model is to be used may be signaled from an encoder to a decoder. In one example, the information may be determined based on a rate-distortion (RD) loss estimation. Alternatively, the information may be determined based on latent information.

In some alternative embodiments, information on the first model to be used may be determined by a decoder. For example, which first model is to be used may be determined by the decoder. In one example, the information may be determined based on hyperprior information. In another example, the information may be determined through an autoregressive model. In a further example, the information may be determined through a combination of hyperprior information and an autoregressive model. It should be understood that the above illustrations are described merely for purpose of description. The scope of the present disclosure is not limited in this respect.

In some embodiments, at 1202, a context parameter may be determined based on a quantized latent representation of the data by using the first model. Moreover, the probability distribution may be generated based on the context parameter. In one example, for determine the context parameter, an attention calculation may be performed based on the quantized latent representation. Furthermore, the context parameter may be generated based on a result of the attention calculation by using at least one subnetwork.

In some embodiments, for performing the attention calculation, a relationship between coded elements and a current element of a quantized latent representation of the data may be generated, and the result of the attention calculation may be generated based on the relationship. The relationship may be determined in an autoregressive way.

In some embodiments, a query, a key and a value for performing the attention calculation may be determined based on the quantized latent representation. In one example, the query may be determined based on the quantized latent representation by using a first subnetwork, the key may be determined based on the quantized latent representation by using a second subnetwork, and the value may be determined based on the quantized latent representation by using a third subnetwork. The first subnetwork, the second subnetwork and the third subnetwork may be different from each other. In another example, each of the query, the key and the value may be the quantized latent representation.

In some embodiments, the relationship may be represented by a relation matrix, and a mask may be applied on the relation matrix for generating the result. For example, a strictly lower triangle matrix may be used for generating the result. As used herein, the term “lower triangle matrix” (also referred to as “lower triangular matrix”) may refer to a matrix in which all elements above the main diagonal are zeros, i.e., a matrix A=[aᵢⱼ] such that aᵢⱼ=0 for i<j. The term “strictly lower triangle matrix” (also referred to as “strictly lower triangular matrix”) may refer to a lower triangular matrix having zeros along the diagonal as well as the upper portion, i.e., a matrix A=[aᵢⱼ] such that aᵢⱼ=0 for i<=j.

In some embodiments, the mask may be the strictly lower triangle matrix. Alternatively, the mask may be a subset of the strictly lower triangle matrix. That is, a part of elements of the strictly lower triangle matrix may be used as the mask.

In some embodiments, a lower triangle matrix may be used for generating the result, and elements on a diagonal of the relation matrix may be indicated in the bitstream. In one example, the mask may be the lower triangle matrix. Alternatively, the mask may be a subset of the lower triangle matrix. That is, a part of elements of the lower triangle matrix may be used as the mask.

In some embodiments, a lower triangle matrix may be used for generating the result, and elements on a diagonal of the relation matrix may be set to be sum of the query on channel dimension. In one example, the mask may be the lower triangle matrix. Alternatively, the mask may be a subset of the lower triangle matrix. That is, a part of elements of the lower triangle matrix may be used as the mask.

In some embodiments, a lower triangle matrix may be used for generating the result, and elements on a diagonal of the relation matrix may be determined based on additional information. By way of example, the additional information may comprise at least one of an output of an autoregressive model or an output of a hyperprior model. In one example, the mask may be the lower triangle matrix. Alternatively, the mask may be a subset of the lower triangle matrix. That is, a part of elements of the lower triangle matrix may be used as the mask.

In some embodiments, the full relation matrix may be used for generating the result, and elements on an upper triangle part of the relation matrix may be determined based on additional information. By way of example, the additional information may comprise at least one of an output of an autoregressive model or an output of a hyperprior model.

In some embodiments, a plurality of attention modules may be used for performing the attention calculation. By way of example, an output of one of the plurality of attention modules may be determined to be the result of the attention calculation. Alternatively, the result of the attention calculation may be generated by performing an aggregation process on outputs of the plurality of attention modules. In one example, the aggregation process may comprise concatenation in a channel or spatial domain. In another example, the aggregation process may comprise a linear operation, such as addition and/or subtraction.

In some embodiments, a key and a value for performing the attention calculation may be determined based on the quantized latent representation. A query for performing the attention calculation may be determined based on additional information. By way of example, the additional information may be determined based on at least one of an output of a hyperprior model or an output of an autoregressive model. In one example, the query may be determined based on the additional information by using a first subnetwork, the key may be determined based on the quantized latent representation by using a second subnetwork, and the value may be determined based on the quantized latent representation by using a third subnetwork. In another example, the query may be the additional information, and each of the key and the value may be the quantized latent representation.

In some embodiments, the relationship may be represented by a relation matrix, and a mask may be applied on the relation matrix for generating the result. In some embodiments, a strictly triangle matrix may be used for generating the result. By way of example, the strictly triangle matrix may be a strictly lower triangle matrix, and the mask may be the strictly lower triangle matrix or a subset of the strictly lower triangle matrix.

In some alternative embodiments, a triangle matrix may be used for generating the result, and elements on a diagonal of the relation matrix may be determined based on a self-correlation of the query. By way of example, the triangle matrix may be a lower triangle matrix, and the mask may be the lower triangle matrix or a subset of the lower triangle matrix.

In some embodiments, the entire relation matrix may be used for generating the result, and elements on an upper triangle part of the relation matrix may be determined based on using additional information as the query and the key. Alternatively, a subset of the relation matrix may be used for generating the result, and elements on an upper triangle part of the relation matrix may be determined based on using additional information as the query and the key.

In some embodiments, a plurality of attention modules may be used for performing the attention calculation. By way of example, an output of one of the plurality of attention modules may be determined to be the result of the attention calculation. Alternatively, the result of the attention calculation may be generated by performing an aggregation process on outputs of the plurality of attention modules. In one example, the aggregation process may comprise concatenation in a channel or spatial domain. In another example, the aggregation process may comprise a linear operation, such as addition or subtraction.

In some embodiments, the conversion may be performed by using a second model with the attention mechanism. By way of example, the second model may be designed based on a transformer architecture and may be referred to as a transformer model, and/or the like. In one example, a prediction associated with the data for performing the conversion may be determined by using the second model. For example, the prediction may comprise at least one of an intra prediction or an inter prediction. In another example, motion information associated with the data for performing the conversion may be determined by using the second model. For example, the motion information may comprise at least one of a motion vector, an optical flow or latent motion information. In some embodiments, the data may comprise a plurality of frames, and an input of the second model may comprise coded frames of the plurality of frames.

According to further embodiments of the present disclosure, a non-transitory computer-readable recording medium is provided. The non-transitory computer-readable recording medium stores a bitstream of data which is generated by a method performed by an apparatus for data processing. According to the method, a probability distribution for entropy coding associated with the bitstream is determined by using a first model with an attention mechanism. Moreover, the bitstream is generated based on the probability distribution.

According to still further embodiments of the present disclosure, a method for storing bitstream of a video is provided. In the method, a probability distribution for entropy coding associated with the bitstream is determined by using a first model with an attention mechanism. Moreover, the bitstream is generated based on the probability distribution, and the bitstream is stored in a non-transitory computer-readable recording medium.

Implementations of the present disclosure can be described in view of the following clauses, the features of which can be combined in any reasonable manner.

Clause 1. A method for data processing, comprising: determining, by using a first model with an attention mechanism during a conversion between data and a bitstream of the data, a probability distribution for entropy coding associated with the bitstream; and performing the conversion based on the probability distribution.

Clause 2. The method of clause 1, wherein the first model comprises a transformer model or a transformer context model.

Clause 3. The method of any of clauses 1-2, wherein the probability distribution is determined by using a combination of the first model with an autoregressive model and a hyperprior model.

Clause 4. The method of clause 3, wherein determining the probability distribution comprises: generating intermediate information based on a quantized latent representation of the data by using the first model; and generating the probability distribution based on the intermediate information and an output of the autoregressive model and an output of the hyperprior model.

Clause 5. The method of clause 4, wherein the probability distribution is generated by using a further model different from the first model.

Clause 6. The method of clause 3, wherein determining the probability distribution comprises: generating intermediate information based on a quantized latent representation of the data and a first output of the autoregressive model by using the first model; and generating the probability distribution based on the intermediate information and a second output of the hyperprior model.

Clause 7. The method of clause 6, wherein the probability distribution is generated based on the intermediate information and the second output by a further model.

Clause 8. The method of clause 6, wherein the probability distribution is generated by combining the intermediate information and the second output directly.

Clause 9. The method of clause 3, wherein determining the probability distribution comprises: generating intermediate information based on a quantized latent representation of the data and a second output of the hyperprior model by using the first model; and generating the probability distribution based on the intermediate information and a first output of the autoregressive model.

Clause 10. The method of clause 9, wherein the probability distribution is generated based on the intermediate information and the first output by a further model.

Clause 11. The method of clause 10, wherein the probability distribution is generated by combining the intermediate information and the first output directly.

Clause 12. The method of clause 3, wherein determining the probability distribution comprises: generating intermediate information based on a quantized latent representation of the data and an output of a further model by using the first model; and generating the probability distribution based on the intermediate information, a first output of the autoregressive model and a second output of the hyperprior model.

Clause 13. The method of clause 12, wherein an input of the further model comprises at least one of: the data, a latent representation of the data, or a quantized latent representation of the data.

Clause 14. The method of any of clauses 1-13, wherein information on whether the probability distribution is determined by using a combination of the first model with an autoregressive model and a hyperprior model is indicated in the bitstream.

Clause 15. The method of any of clauses 1-13, wherein information on whether the probability distribution is determined by using a combination of the first model with an autoregressive model and a hyperprior model is determined by a decoder.

Clause 16. The method of any of clauses 1-2, wherein the probability distribution is determined by using a combination of the first model with a hyperprior model.

Clause 17. The method of clause 16, wherein the probability distribution is determined based on a quantized latent representation of the data and an output of the hyperprior model by using the first model.

Clause 18. The method of clause 16, wherein an input of the first model comprises a quantized latent representation of the data.

Clause 19. The method of clause 18, wherein the probability distribution is determined based on an output of the first model and an output of the hyperprior model by using a further model.

Clause 20. The method of clause 18, wherein the probability distribution is determined as an output of the first model.

Clause 21. The method of any of clauses 1-2, wherein the probability distribution is determined by using a combination of the first model with an autoregressive model.

Clause 22. The method of clause 21, wherein the probability distribution is determined based on a quantized latent representation of the data and an output of the autoregressive model by using the first model.

Clause 23. The method of clause 21, wherein an input of the first model comprises a quantized latent representation of the data.

Clause 24. The method of clause 23, wherein the probability distribution is determined based on an output of the first model and an output of the autoregressive model by using a further model.

Clause 25. The method of clause 23, wherein the probability distribution is determined as an output of the first model.

Clause 26. The method of any of clauses 1-2, wherein an input of the first model comprises a quantized latent representation of the data.

Clause 27. The method of clause 26, wherein the input further comprises an output of a further model.

Clause 28. The method of clause 27, wherein an input of the further model comprises at least one of: the data, or a quantized latent representation of the data.

Clause 29. The method of any of clauses 1-2, wherein information on whether the first model is used to replace an autoregressive model is indicated in the bitstream, information on whether the first model is used to replace a hyperprior model is indicated in the bitstream, or information on whether the first model is used to replace the autoregressive model and the hyperprior model is indicated in the bitstream.

Clause 30. The method of any of clauses 1-2, wherein information on whether the first model is used to replace an autoregressive model is determined by a decoder, information on whether the first model is used to replace a hyperprior model is determined by a decoder, or information on whether the first model is used to replace the autoregressive model and the hyperprior model is determined by a decoder.

Clause 31. The method of any of clauses 1-2, wherein the probability distribution is determined by using a plurality of the first models.

Clause 32. The method of clause 31, determining the probability distribution comprises: determining a first candidate probability distribution for the entropy coding by using one of the plurality of the first models; determining a second candidate probability distribution for the entropy coding by using a further one of the plurality of the first models; and generating the probability distribution based on the first candidate probability distribution and the second candidate probability distribution.

Clause 33. The method of clause 32, wherein the probability distribution is generated based on a weighted sum of the first candidate probability distribution and the second candidate probability distribution, and weights for the first candidate probability distribution and the second candidate probability distribution are determined based on learnable parameters or latent information.

Clause 34. The method of clause 32, wherein the probability distribution is generated by at least one further model.

Clause 35. The method of clause 31, wherein one of the plurality of the first models is used for a first element at a first spatial location of a quantized latent representation of the data, and a further one of the plurality of the first models is used for a second element at a second spatial location of the quantized latent representation, the second element spatial location being different from the first element spatial location.

Clause 36. The method of clause 31, wherein information on the first model to be used is indicated in the bitstream.

Clause 37. The method of clause 36, wherein the information is determined based on a rate-distortion (RD) loss estimation.

Clause 38. The method of clause 36, wherein the information is determined based on latent information.

Clause 39. The method of clause 31, wherein information on the first model to be used is determined by a decoder.

Clause 40. The method of clause 39, wherein the information is determined based on hyperprior information.

Clause 41. The method of clause 39, wherein the information is determined through an autoregressive model.

Clause 42. The method of clause 39, wherein the information is determined through a combination of hyperprior information and an autoregressive model.

Clause 43. The method of any of clauses 1-2, wherein determining the probability distribution comprises: determining a context parameter based on a quantized latent representation of the data by using the first model; and generating the probability distribution based on the context parameter.

Clause 44. The method of clause 43, wherein determining the context parameter comprises: performing an attention calculation based on the quantized latent representation; and generating the context parameter based on a result of the attention calculation by using at least one subnetwork.

Clause 45. The method of clause 44, wherein performing the attention calculation comprises: generating a relationship between coded elements and a current element of a quantized latent representation of the data; and generating the result based on the relationship.

Clause 46. The method of clause 45, wherein the relationship is determined in an autoregressive way.

Clause 47. The method of any of clauses 44-46, wherein a query, a key and a value for performing the attention calculation is determined based on the quantized latent representation.

Clause 48. The method of clause 47, wherein the query is determined based on the quantized latent representation by using a first subnetwork, the key is determined based on the quantized latent representation by using a second subnetwork, and the value is determined based on the quantized latent representation by using a third subnetwork, the first subnetwork, the second subnetwork and the third subnetwork being different from each other.

Clause 49. The method of clause 47, wherein each of the query, the key and the value is the quantized latent representation.

Clause 50. The method of any of clauses 45-49, wherein the relationship is represented by a relation matrix, and a mask is applied on the relation matrix for generating the result.

Clause 51. The method of clause 50, wherein a strictly lower triangle matrix is used for generating the result.

Clause 52. The method of clause 51, wherein the mask is the strictly lower triangle matrix.

Clause 53. The method of clause 51, wherein the mask is a subset of the strictly lower triangle matrix.

Clause 54. The method of clause 50, wherein a lower triangle matrix is used for generating the result, and elements on a diagonal of the relation matrix are indicated in the bitstream.

Clause 55. The method of clause 54, wherein the mask is the lower triangle matrix.

Clause 56. The method of clause 54, wherein the mask is a subset of the lower triangle matrix.

Clause 57. The method of clause 50, wherein a lower triangle matrix is used for generating the result, and elements on a diagonal of the relation matrix are set to be sum of the query on channel dimension.

Clause 58. The method of clause 57, wherein the mask is the lower triangle matrix.

Clause 59. The method of clause 57, wherein the mask is a subset of the lower triangle matrix.

Clause 60. The method of clause 50, wherein a lower triangle matrix is used for generating the result, and elements on a diagonal of the relation matrix are determined based on additional information.

Clause 61. The method of clause 60, wherein the mask is the lower triangle matrix.

Clause 62. The method of clause 60, wherein the mask is a subset of the lower triangle matrix.

Clause 63. The method of any of clauses 60-62, wherein the additional information comprises at least one of an output of an autoregressive model or an output of a hyperprior model.

Clause 64. The method of clause 50, wherein the full relation matrix is used for generating the result, and elements on an upper triangle part of the relation matrix are determined based on additional information.

Clause 65. The method of clause 64, wherein the additional information comprises at least one of an output of an autoregressive model or an output of a hyperprior model.

Clause 66. The method of any of clauses 44-65, wherein a plurality of attention modules are used for performing the attention calculation.

Clause 67. The method of clause 66, wherein an output of one of the plurality of attention modules is determined to be the result of the attention calculation.

Clause 68. The method of clause 66, wherein the result of the attention calculation is generated by performing an aggregation process on outputs of the plurality of attention modules.

Clause 69. The method of clause 68, wherein the aggregation process comprises concatenation in a channel or spatial domain.

Clause 70. The method of clause 68, wherein the aggregation process comprises a linear operation.

Clause 71. The method of clause 70, wherein the linear operation comprises addition or subtraction.

Clause 72. The method of any of clauses 45-46, wherein a key and a value for performing the attention calculation is determined based on the quantized latent representation, and a query for performing the attention calculation is determined based on additional information.

Clause 73. The method of clause 72, wherein the additional information is determined based on at least one of an output of a hyperprior model or an output of an autoregressive model.

Clause 74. The method of any of clauses 72-73, wherein the query is determined based on the additional information by using a first subnetwork, the key is determined based on the quantized latent representation by using a second subnetwork, and the value is determined based on the quantized latent representation by using a third subnetwork.

Clause 75. The method of any of clauses 72-73, wherein the query is the additional information, and each of the key and the value is the quantized latent representation.

Clause 76. The method of any of clauses 72-75, wherein the relationship is represented by a relation matrix, and a mask is applied on the relation matrix for generating the result.

Clause 77. The method of clause 76, wherein a strictly triangle matrix is used for generating the result.

Clause 78. The method of clause 77, wherein the strictly triangle matrix is a strictly lower triangle matrix, and the mask is the strictly lower triangle matrix.

Clause 79. The method of clause 77, wherein the strictly triangle matrix is a strictly lower triangle matrix, and the mask is a subset of the strictly lower triangle matrix.

Clause 80. The method of clause 76, wherein a triangle matrix is used for generating the result, and elements on a diagonal of the relation matrix are determined based on a self-correlation of the query.

Clause 81. The method of clause 80, wherein the triangle matrix is a lower triangle matrix, and the mask is the lower triangle matrix.

Clause 82. The method of clause 80, wherein the triangle matrix is a lower triangle matrix, and the mask is a subset of the lower triangle matrix.

Clause 83. The method of clause 76, wherein the entire relation matrix is used for generating the result, and elements on an upper triangle part of the relation matrix are determined based on using additional information as the query and the key.

Clause 84. The method of clause 76, wherein a subset of the relation matrix is used for generating the result, and elements on an upper triangle part of the relation matrix are determined based on using additional information as the query and the key.

Clause 85. The method of any of clauses 72-84, wherein a plurality of attention modules are used for performing the attention calculation.

Clause 86. The method of clause 85, wherein an output of one of the plurality of attention modules is determined to be the result of the attention calculation.

Clause 87. The method of clause 85, wherein the result of the attention calculation is generated by performing an aggregation process on outputs of the plurality of attention modules.

Clause 88. The method of clause 87, wherein the aggregation process comprises concatenation in a channel or spatial domain.

Clause 89. The method of clause 87, wherein the aggregation process comprises a linear operation.

Clause 90. The method of clause 89, wherein the linear operation comprises addition or subtraction.

Clause 91. The method of any of clauses 1-90, wherein the conversion is performed by using a second model with the attention mechanism.

Clause 92. The method of clause 91, wherein the second model comprises a transformer model.

Clause 93. The method of clause 91, wherein a prediction associated with the data for performing the conversion is determined by using the second model.

Clause 94. The method of clause 93, wherein the prediction comprises at least one of an intra prediction or an inter prediction.

Clause 95. The method of any of clauses 91-94, wherein motion information associated with the data for performing the conversion is determined by using the second model.

Clause 96. The method of clause 95, wherein the motion information comprises at least one of a motion vector, an optical flow or latent motion information.

Clause 97. The method of any of clauses 91-96, wherein the data comprises a plurality of frames, and an input of the second model comprises coded frames of the plurality of frames.

Clause 98. The method of any of clauses 1-97, wherein the data comprises at least one of: an image, a picture of a video, or a video.

Clause 99. The method of any of clauses 1-98, wherein the conversion includes encoding the data into the bitstream.

Clause 100. The method of any of clauses 1-98, wherein the conversion includes decoding the data from the bitstream.

Clause 101. An apparatus for data processing comprising a processor and a non-transitory memory with instructions thereon, wherein the instructions upon execution by the processor, cause the processor to perform a method in accordance with any of clauses 1-100.

Clause 102. A non-transitory computer-readable storage medium storing instructions that cause a processor to perform a method in accordance with any of clauses 1-100.

Clause 103. A non-transitory computer-readable recording medium storing a bitstream of data which is generated by a method performed by an apparatus for data processing, wherein the method comprises: determining, by using a first model with an attention mechanism, a probability distribution for entropy coding associated with the bitstream; and generating the bitstream based on the probability distribution.

Clause 104. A method for storing a bitstream of data, comprising: determining, by using a first model with an attention mechanism, a probability distribution for entropy coding associated with the bitstream; generating the bitstream based on the probability distribution; and storing the bitstream in a non-transitory computer-readable recording medium.

### Example Device

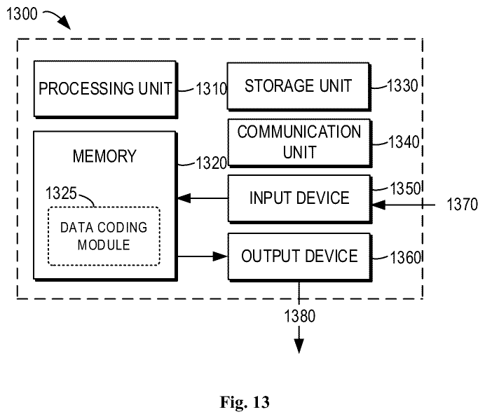

FIG. 13 illustrates a block diagram of a computing device 1300 in which various embodiments of the present disclosure can be implemented. The computing device 1300 may be implemented as or included in the source device 110 (or the data encoder 114) or the destination device 120 (or the data decoder 124).

It would be appreciated that the computing device 1300 shown in FIG. 13 is merely for purpose of illustration, without suggesting any limitation to the functions and scopes of the embodiments of the present disclosure in any manner.

As shown in FIG. 13, the computing device 1300 includes a general-purpose computing device 1300. The computing device 1300 may at least comprise one or more processors or processing units 1310, a memory 1320, a storage unit 1330, one or more communication units 1340, one or more input devices 1350, and one or more output devices 1360.

In some embodiments, the computing device 1300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1300 can support any type of interface to a user (such as “wearable” circuitry and the like).

The processing unit 1310 may be a physical or virtual processor and can implement various processes based on programs stored in the memory 1320. In a multi-processor system, multiple processing units execute computer executable instructions in parallel so as to improve the parallel processing capability of the computing device 1300. The processing unit 1310 may also be referred to as a central processing unit (CPU), a microprocessor, a controller or a microcontroller.

The computing device 1300 typically includes various computer storage medium. Such medium can be any medium accessible by the computing device 1300, including, but not limited to, volatile and non-volatile medium, or detachable and non-detachable medium. The memory 1320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1330 may be any detachable or non-detachable medium and may include a machine-readable medium such as a memory, flash memory drive, magnetic disk or another other media, which can be used for storing information and/or data and can be accessed in the computing device 1300.

The computing device 1300 may further include additional detachable/non-detachable, volatile/non-volatile memory medium. Although not shown in FIG. 13, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1340 communicates with a further computing device via the communication medium. In addition, the functions of the components in the computing device 1300 can be implemented by a single computing cluster or multiple computing machines that can communicate via communication connections. Therefore, the computing device 1300 can operate in a networked environment using a logical connection with one or more other servers, networked personal computers (PCs) or further general network nodes.

The input device 1350 may be one or more of a variety of input devices, such as a mouse, keyboard, tracking ball, voice-input device, and the like. The output device 1360 may be one or more of a variety of output devices, such as a display, loudspeaker, printer, and the like. By means of the communication unit 1340, the computing device 1300 can further communicate with one or more external devices (not shown) such as the storage devices and display device, with one or more devices enabling the user to interact with the computing device 1300, or any devices (such as a network card, a modem and the like) enabling the computing device 1300 to communicate with one or more other computing devices, if required. Such communication can be performed via input/output (I/O) interfaces (not shown).

In some embodiments, instead of being integrated in a single device, some or all components of the computing device 1300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1300 may be used to implement data encoding/decoding in embodiments of the present disclosure. The memory 1320 may include one or more data coding modules 1325 having one or more program instructions. These modules are accessible and executable by the processing unit 1310 to perform the functionalities of the various embodiments described herein.

In the example embodiments of performing data encoding, the input device 1350 may receive data as an input 1370 to be encoded. The data may be processed, for example, by the data coding module 1325, to generate an encoded bitstream. The encoded bitstream may be provided via the output device 1360 as an output 1380.

In the example embodiments of performing data decoding, the input device 1350 may receive an encoded bitstream as the input 1370. The encoded bitstream may be processed, for example, by the data coding module 1325, to generate decoded data. The decoded data may be provided via the output device 1360 as the output 1380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method for visual data processing, comprising:
determining, by using a first model with an attention mechanism during a conversion between visual data and a bitstream of the visual data, a probability distribution for entropy coding associated with the bitstream; and
performing the conversion based on the probability distribution.

2. The method of claim 1, wherein the first model comprises a transformer model or a transformer context model.

3. The method of claim 1, wherein the probability distribution is determined by using a combination of the first model with an autoregressive model and a hyperprior model.

4. The method of claim 3, wherein determining the probability distribution comprises:
generating intermediate information based on a quantized latent representation of the visual data by using the first model; and
generating the probability distribution based on the intermediate information and an output of the autoregressive model and an output of the hyperprior model.

5. The method of claim 4, wherein the probability distribution is generated by using a further model different from the first model.

6. The method of claim 1, wherein information on whether the probability distribution is determined by using a combination of the first model with an autoregressive model and a hyperprior model is indicated in the bitstream, or
wherein information on whether the probability distribution is determined by using a combination of the first model with an autoregressive model and a hyperprior model is determined by a decoder, or
wherein the probability distribution is determined by using a combination of the first model with a hyperprior model, or
wherein the probability distribution is determined by using a combination of the first model with an autoregressive model, or
wherein an input of the first model comprises a quantized latent representation of the visual data, or
wherein information on whether the first model is used to replace an autoregressive model is indicated in the bitstream, or information on whether the first model is used to replace a hyperprior model is indicated in the bitstream, or information on whether the first model is used to replace the autoregressive model and the hyperprior model is indicated in the bitstream, or
wherein information on whether the first model is used to replace an autoregressive model is determined by a decoder, or information on whether the first model is used to replace a hyperprior model is determined by a decoder, or information on whether the first model is used to replace the autoregressive model and the hyperprior model is determined by a decoder, or
wherein the probability distribution is determined by using a plurality of the first models.

7. The method of claim 1, wherein determining the probability distribution comprises:
determining a context parameter based on a quantized latent representation of the visual data by using the first model; and
generating the probability distribution based on the context parameter.

8. The method of claim 7, wherein determining the context parameter comprises:
performing an attention calculation based on the quantized latent representation; and
generating the context parameter based on a result of the attention calculation by using at least one subnetwork.

9. The method of claim 8, wherein performing the attention calculation comprises:
generating a relationship between coded elements and a current element of a quantized latent representation of the visual data; and
generating the result based on the relationship.

10. The method of claim 9, wherein the relationship is determined in an autoregressive way.

11. The method of claim 8, wherein a query, a key and a value for performing the attention calculation is determined based on the quantized latent representation.

12. The method of claim 11, wherein the query is determined based on the quantized latent representation by using a first subnetwork,
the key is determined based on the quantized latent representation by using a second subnetwork, and
the value is determined based on the quantized latent representation by using a third subnetwork, the first subnetwork, the second subnetwork and the third subnetwork being different from each other.

13. The method of claim 9, wherein the relationship is represented by a relation matrix, and a mask is applied on the relation matrix for generating the result, or
wherein a key and a value for performing the attention calculation is determined based on the quantized latent representation, and a query for performing the attention calculation is determined based on additional information.

14. The method of claim 1, wherein the conversion is performed by using a second model with the attention mechanism.

15. The method of claim 14, wherein the second model comprises a transformer model, or
wherein a prediction associated with the visual data for performing the conversion is determined by using the second model, or
wherein motion information associated with the visual data for performing the conversion is determined by using the second model, or
wherein the visual data comprises a plurality of frames, and an input of the second model comprises coded frames of the plurality of frames.

16. The method of claim 1, wherein the visual data comprises at least one of:
an image,
a picture of a video, or
a video.

17. The method of claim 1, wherein the conversion includes encoding the visual data into the bitstream, or
wherein the conversion includes decoding the visual data from the bitstream.

18. An apparatus for visual data processing comprising a processor and a non-transitory memory with instructions thereon, wherein the instructions upon execution by the processor, cause the processor to perform acts comprising:
determining, by using a first model with an attention mechanism during a conversion between visual data and a bitstream of the visual data, a probability distribution for entropy coding associated with the bitstream; and
performing the conversion based on the probability distribution.

19. A non-transitory computer-readable storage medium storing instructions that cause a processor to perform acts comprising:
determining, by using a first model with an attention mechanism during a conversion between visual data and a bitstream of the visual data, a probability distribution for entropy coding associated with the bitstream; and
performing the conversion based on the probability distribution.

20. A non-transitory computer-readable recording medium storing a bitstream of visual data which is generated by a method performed by an apparatus for visual data processing, wherein the method comprises:
determining, by using a first model with an attention mechanism, a probability distribution for entropy coding associated with the bitstream; and
generating the bitstream based on the probability distribution.
